(19) United States
(12) Patent Application Publication
(10) Pub. No.: US 2023/0206521 A1
(43) Pub. Date: Jun. 29, 2023

(54) METHOD OF MANUFACTURING AND REPRODUCING PICTURE GUESTBOOK USING VECTOR STROKE

(71) Applicant: BK LTD., Gumi-si (KR)

(72) Inventor: Jae Hyun BAHK, Gumi-si (KR)

(21) Appl. No.: 18/085,885

(22) Filed: Dec. 21, 2022

(30) Foreign Application Priority Data
Dec. 27, 2021 (KR) 10-2021-0188176

(51) Int. Cl. G06T 11/20; G06T 11/00

(52) U.S. Cl. CPC G06T 11/203; G06T 11/001

(57) ABSTRACT

Provided is a method of drawing and replaying a picture guestbook using a vector stroke, the method including: displaying an original vector image; determining a selected vector stroke among all vector strokes of the original vector image according to a user input, and detecting an operation step of the selected vector stroke; receiving a picture guestbook drawn on the original vector image, and obtaining vector stroke information of the picture guestbook based on the detected operation step; and drawing and replaying the picture guestbook based on the vector stroke information of the original vector image.

### CROSS-REFERENCE TO RELATED APPLICATIONS

This application claims priority to and the benefit of Korean Patent Application No. 10-2021-0188176 filed in the Korean Intellectual Property Office on Dec. 27, 2021, the entire contents of which are incorporated herein by reference.

### BACKGROUND OF THE INVENTION

### 1. Field of the Invention

The present invention relates to a method of drawing (or painting, Hereinafter, drawing means including both drawing and painting) and replaying a picture guestbook using a vector stroke, and more particularly, to a method of drawing and replaying a picture guestbook, in which a picture guestbook that allows a picture or a letter to be drawn and replayed by using a vector stroke on a vector image of a creator, which is drawn in a vector scheme, is drawn, so that empathy for a paintings is shared between the creator and a user or the user and another user, and communication is enabled between the creator and the user or the user and another user.

### 2. Description of the Related Art

Computer graphics may be largely classified into a bitmap scheme and a vector scheme. In general, when a letter or a picture is written or drawn on a screen by using a mobile terminal, a bitmap scheme is mainly used. As shown in FIG. 1, the bitmap scheme may express an image by using a pixel (PX) grid. The bitmap scheme may include only color information for each pixel PX, and only the color information for each pixel PX may be modified.

Since the bitmap scheme stores only an image that is finally completed, only a static image may be shared with other users. Therefore, in a case of an image produced in the bitmap scheme, in order for other users to write reviews or guestbooks about the image, a scheme of inputting text in an input window that is separately provided or inserting a template formed of an emoticon or a separate picture may be used.

For example, as shown in FIG. 2, users User #1 to User #3 may write a work review or a guestbook by writing articles such as “Great job” and “I like apple drawing” or inserting an emoticon having a finger shape or the like in at least one input window 20 that is provided separately from an image 10 of a work.

Since the bitmap scheme may not store and replay an image replaying process, when a picture or a letter is drawn or written on an original bitmap image, the original bitmap image may be obscured, which may disrupt appreciation of the work. Even when an image on which a work review or a guestbook is written is produced separately from the original bitmap image, since the image is also a static bitmap image, it may be difficult to completely separate the image from the original bitmap image.

In addition, even when a replaying process is replayed and shared with other users by recording a process of drawing an image with a bitmap as a video, since it is impossible to edit the video, a separate input window has to be used to write a work review or a guestbook for the video.

As described above, since contents such as bitmap images and videos are provided with work reviews or guestbooks separately from a final version of a work, only a static expression on a portion of the work that a user likes or dislikes may be provided, so that there may be restrictions on expressing empathy for a work or one's feelings between a creator and a user or between a user and another user.

Meanwhile, unlike the bitmap scheme, the vector scheme may include stroke information rather than the color information for each pixel, so that a picture and a letter that has been drawn or written may be corrected. The vector scheme refers to a scheme of using an object such as a point, a straight line, a curved line, or a polygon based on a mathematical equation to represent a picture or a letter in computer science. In physics, a vector refers to a quantity that has both a magnitude and a direction.

The vector scheme may be a scheme in which an electron beam continuously moves along a line segment or a curved line appearing on a graphic screen to display an image on the screen, which is convenient for processing a picture or a letter formed of a stroke, and has an advantage of high resolution. In other words, the vector scheme may produce a digital image by arranging a stroke or a shape in a given two-dimensional or three-dimensional space through a series of commands or mathematical expressions.

According to the vector scheme, graphic files, which are results of creative activities of artists, may be created and stored in the form of a series of vector statements. For example, a vector graphic file may store information on positions of a series of points to be connected instead of bit information stored in each pixel in order to draw a stroke. For example, as shown in FIG. 3, when a stroke is drawn with a black color, the stroke may be converted into a vector stroke, and coordinate values of guide lines Side 1 and Side 2, a thickness Width and the like for the stroke may be stored as information on the vector stroke.

Accordingly, a size of the vector graphic file may be relatively small as compared with the bitmap scheme, and vector strokes that are stored sequential information for each operation step may be loaded and additionally drawn, modified, or replayed. Therefore, there is a demand for a new technology capable of overcoming limitations of the bitmap scheme and producing work reviews or guestbooks suitable for a vector image.

### SUMMARY OF THE INVENTION

One embodiment of the present invention provides a method of drawing and replaying a picture guestbook, in which a picture guestbook that allows a picture or a letter to be drawn and replayed by using a vector stroke on a vector image of a creator, which is drawn in a vector scheme, may be drawn, so that empathy for a work may be shared between the creator and a user or the user and another user, and communication may be enabled between the creator and the user or the user and another user.

According to embodiments, a method of drawing and replaying a picture guestbook using a vector stroke includes: displaying an original vector image; determining a selected vector stroke among all vector strokes of the original vector image according to a user input, and detecting an operation step of the selected vector stroke; receiving a picture guestbook drawn on the original vector image, and obtaining vector stroke information of the picture guestbook based on the detected operation step; and drawing and replaying the picture guestbook based on the vector stroke information of the original vector image.

The disclosed technology may have the following effects. However, since it does not mean that a specific embodiment has to include all of the following effects or only the following effects, the scope of the disclosed technology should not be understood as being limited by the following effects.

According to the method of drawing and replaying the picture guestbook of one embodiment of the present invention, a picture guestbook that allows a picture or a letter to be drawn and replayed by using a vector stroke on a vector image of a creator, which is drawn in a vector scheme, may be drawn, so that empathy for a work can be shared between the creator and a user or the user and another user, and communication can be enabled between the creator and the user or the user and another user.

### BRIEF DESCRIPTION OF THE DRAWINGS

FIG. 1 is an exemplary view for describing a process of drawing a picture or a letter in a bitmap scheme.

FIG. 2 is an exemplary view for describing a scheme of writing a guestbook for an image produced in the bitmap scheme.

FIG. 3 is an exemplary view for describing a process of drawing a picture or a letter in a vector scheme.

FIG. 4 is a block diagram showing an apparatus for drawing and replaying a picture guestbook using a vector stroke according to one embodiment of the present invention.

FIG. 5 is a flowchart showing a method of drawing and replaying a picture guestbook using a vector stroke according to one embodiment of the present invention.

FIGS. 6A-6B are exemplary views for describing an original vector image according to one embodiment of the present invention.

FIGS. 7A-7C is an exemplary view for describing a scheme of selecting a vector stroke for which a picture guestbook is to be drawn by a user according to one embodiment of the present invention.

FIGS. 8A-D is another exemplary view for describing a scheme of selecting a vector stroke for which a picture guestbook is to be drawn according to one embodiment of the present invention.

FIGS. 9A-9C is still another exemplary view for describing a scheme of selecting a vector stroke for which a picture guestbook is to be drawn by a user according to one embodiment of the present invention.

FIGS. 10A-10C is yet another exemplary view for describing a scheme of selecting a vector stroke for which a picture guestbook is to be drawn by a user according to one embodiment of the present invention.

FIGS. 11A-11B are still yet another exemplary view for describing a scheme of selecting a vector stroke for which a picture guestbook is to be drawn by a user according to one embodiment of the present invention.

FIGS. 12A-12C are exemplary view for describing a scheme of drawing a picture guestbook according to one embodiment of the present invention.

FIG. 13 is an exemplary view for describing actual replaying of the picture guestbook.

FIGS. 14A-14B are an exemplary view for describing modification of the picture guestbook according to one embodiment of the present invention.

FIGS. 15A-15D are an exemplary view for describing restrictions on drawing the picture guestbook according to one embodiment of the present invention.

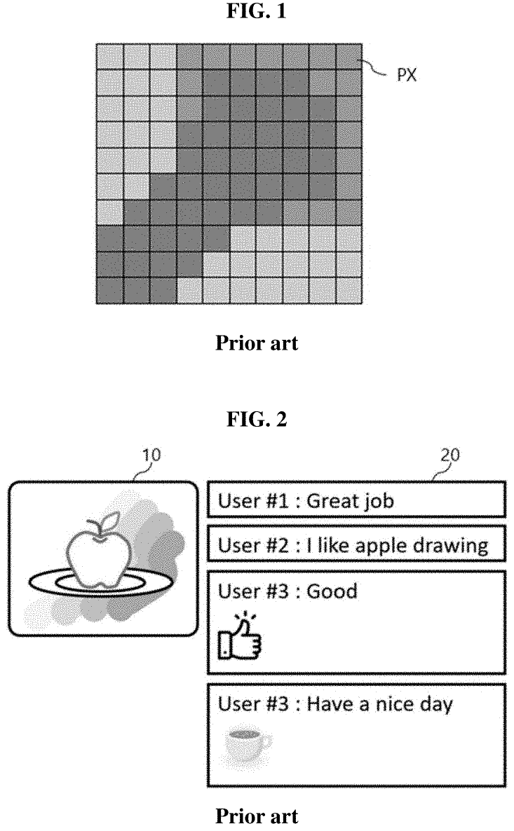

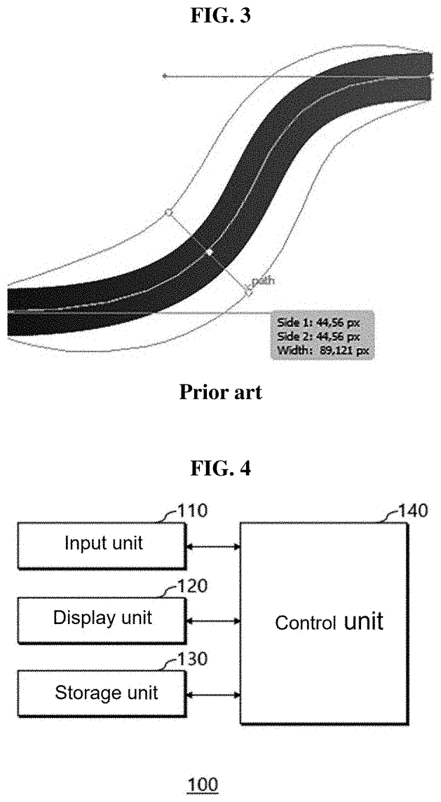

### DETAILED DESCRIPTION OF THE INVENTION

Since the description of the present invention corresponds to merely an embodiment for structural or functional description, the scope of the present invention should not be construed as being limited by an embodiment in the following description. In other words, since the embodiments may have various changes and various forms, the scope of the present invention is to be understood as encompassing equivalents capable of realizing the technical idea. In addition, since it does not mean that a specific embodiment has to include all of objects or effects presented in the present disclosure or only the objects or the effects presented in the present disclosure, the scope of the present invention should not be understood as being limited by the objects or the effects presented in the present disclosure.

Meanwhile, meanings of terms described in the present disclosure are to be understood as follows. Terms such as “first” and “second” are used to distinguish one element from another element, and the scope of the present invention should not be limited by the terms. For example, a first element may be termed as a second element, and similarly, a second element may be termed as a first element.

When one element is described as being “connected” to another element, it is to be understood as being connected to the other element directly, but also as possibly having another element in between. However, when one element is described as being “directly connected” to another element, it is to be understood that there is no other element in between. Meanwhile, other expressions describing relation between elements, that is, “between” and “directly between” or “adjacent to” and “directly adjacent to” are to be interpreted similarly as described above.

Expressions in a singular form are to be understood as including a meaning of a plural form unless the context explicitly indicates otherwise, a term such as “comprising” or “including” is intended to designate the presence of characteristics, numbers, steps, operations, elements, parts, or combinations thereof that are implemented, and should not be understood to preclude any possibility of the presence or addition of one or more other characteristics, numbers, steps, operations, elements, parts, or combinations thereof.

The reference characters (e.g., a, b, c, etc.) in the step are used for convenience of description, so that the reference characters do not describe an order of the steps, and the steps may occur in an order that is different from a specified order unless the context explicitly describes a specific order. In other words, the steps may occur in an order that is the same as the specified order, may be performed substantially at the same time, or may be performed in a reverse order.

The present invention may be implemented as a computer-readable code on a computer-readable recording medium, and the computer-readable recording medium may include all types of recording devices in which data that is readable by a computer system is stored. An example of the computer-readable recording medium includes a ROM, a RAM, a CD-ROM, a magnetic tape, a floppy disk, and an optical data storage device. In addition, the computer-readable recording medium may be distributed over computer systems connected through a network, so that the computer-readable code may be stored and executed in a distributed manner.

Unless defined otherwise, all terms used herein have the same meaning as how they are generally understood by a person having ordinary skill in the art to which the present invention pertains. Any term as defined in a general dictionary is to be interpreted as having the same meaning as in the context of the relevant art, and not to be interpreted as having an idealistic or excessively formalistic meaning unless explicitly defined otherwise in the present disclosure.

FIG. 4 is a block diagram showing an apparatus for drawing and replaying a picture guestbook using a vector stroke according to one embodiment of the present invention.

Referring to FIG. 4, according to one embodiment of the present invention, an apparatus 100 for drawing and replaying a picture guestbook using a vector stroke may be operated through a program or an application installed on a user terminal in an executable form so that an operation may be controlled in the user terminal, or the picture guestbook may be drawn and replayed on an original vector image in a vector scheme. For example, the user terminal may include a computing device such as a mobile device, a tablet PC, a desktop PC, and a laptop PC. In this case, the picture guestbook may be defined and described as an image that includes a letter or a picture, which collectively refers to a work review, a guestbook, a comment, an emoticon, a doodling, and the like.

In detail, the apparatus 100 for drawing and replaying the picture guestbook using the vector stroke may include an input unit 110, a display unit 120, a storage unit 130, and a control unit 140. The input unit 110 may receive a user input that is input from a user to draw the picture guestbook. In addition, the input unit 110 may receive user information for identifying the user.

The display unit 120 may display and replay at least one of the original vector image and the picture guestbook on a screen. In this case, for operational convenience of the user, the input unit 110 and the display unit 120 may be integrally formed so as to be implemented as a touch screen having display and input functions. In this case, according to one embodiment of the present invention, a separate input device such as a touch pen capable of touching the touch screen may be included.

The storage unit 130 may store various information necessary for drawing and replaying an image in a vector scheme. For example, the storage unit 130 may store vector stroke information on vector strokes of each of the original vector image and the picture guestbook, the user input, the user information, and the like. The vector stroke information of the original vector image may be downloaded through the Internet or a social networking service (SNS), or may be streamed in real time so as to be stored in the storage unit 130. In addition, the storage unit 130 may store a program or an application for drawing and replaying an image in a vector scheme.

The control unit 140 may execute the program or the application to perform a control to draw and replay an image in a vector scheme. When the picture guestbook is requested to be drawn, the control unit 140 may load the vector stroke information of the original vector image for which the picture guestbook is to be drawn from the storage unit 130 to replay the original vector image.

The control unit 140 may select a vector stroke for which the picture guestbook is to be drawn among all vector strokes of the original vector image according to the user input, and may detect an operation step corresponding to the selected vector stroke. The control unit 140 may obtain vector stroke information of the picture guestbook drawn on the original vector image based on the detected operation step. According to one embodiment of the present invention, vector stroke information may include operation step and attribute information on the vector strokes included in the original vector image or the picture guestbook. In other words, the vector stroke information may include a sequential operation order index, a coordinate value of a guide line generated based on the vector stroke, a stroke thickness, a stroke color, a stroke shape, a type of a pen used, a type of a brush used, stroke transparency, a pen pressure indicating a pressure of a pen being pressed, and the like.

In this case, the control unit 140 may receive a virtual stroke drawn on the original vector image by using a stroke-basis selection pen as the user input, and may select a vector stroke making contact with the virtual stroke among all the vector strokes of the original vector image to detect an operation step of the vector stroke. In addition, the control unit 140 may receive a closed curve or a polygon drawn on the original vector image as the user input, and may select a vector stroke inside the closed curve or the polygon among all the vector strokes of the original vector image to detect an operation step of the vector stroke.

In addition, the control unit 140 may receive a color value or a color selected by using an eyedropper tool as the user input, and may select a vector stroke having the color value corresponding to a character or the selected color among all the vector strokes of the original vector image to detect an operation step of the vector stroke. In addition, the control unit 140 may receive a character corresponding to a stroke order as the user input, and may select a vector stroke corresponding to the received stroke order among all the vector strokes of the original vector image to detect an operation step of the vector stroke.

When a plurality of vector strokes are selected, the control unit 140 may select one of the vector strokes according to a preset user setting. In this case, the user setting may be set to select one of a highest-order stroke, a lowest-order stroke, and an intermediate-order stroke.

The control unit 140 may receive the picture guestbook drawn on the original vector image, and obtain the vector stroke information on the vector strokes of the picture guestbook based on the detected operation step. The control unit 140 may insert and store the picture guestbook into the original vector image in synchronization with the detected operation step of the original vector image. However, one embodiment of the present invention is not limited to the above configuration, and the picture guestbook may be stored in synchronization as a separate file in order to maintain and protect the original vector image and facilitate management.

In addition, the control unit 140 may store an identifier of the user drawing the picture guestbook in the storage unit 130 together with the vector stroke information of the picture guestbook. When modification of the picture guestbook is requested, the control unit 140 may load and display the vector stroke information of the picture guestbook from the storage unit 130, and may update the vector stroke information in response to modification and editing of the picture guestbook.

When the picture guestbook is received, according to one embodiment of the present invention, the control unit 140 may restrict the drawing of the picture guestbook according to a preset rule. In this case, the preset rule may include a drawing area, a number of strokes, a size, a replaying time, and the like of the picture guestbook. In other words, since one user may use an entire screen when a plurality of users draw picture guestbooks, according to one embodiment of the present invention, one user may be restricted to use only a predetermined portion of the original vector image for joint use.

When replaying of the picture guestbook is requested, the control unit 140 may control at least one of a replaying speed and a viewing scheme of the original vector image and the picture guestbook according to a preset user setting. The control unit 140 may replay the picture guestbook at the same speed as the replaying speed of the original vector image, or may replay the picture guestbook at a speed that is changed to be different from the replaying speed of the original vector image (e.g., a ½× speed, a 2× speed, etc.). In this case, the control unit 140 may restrict the replaying time of the picture guestbook to be less than or equal to a preset reference replaying time.

In addition, the control unit 140 may replay the picture guestbook simultaneously with the original vector image, or may replay the picture guestbook separately from the original vector image. In addition, the control unit 140 may replay only the picture guestbook drawn by the user, or may replay the picture guestbook drawn by the user together with a picture guestbook drawn by another user other than the user. Therefore, the user currently drawing the picture guestbook may share picture guestbooks of all users who have selected to view together, such as specific friends, group members, or specific artists.

In addition, according to one embodiment of the present invention, the control unit 140 may determine priority of the replaying of the picture guestbook according to recommendation and non-recommendation in association with an SNS function. For example, the control unit 140 may replay a recommended picture guestbook first, or may replay the picture guestbook drawn by the user first.

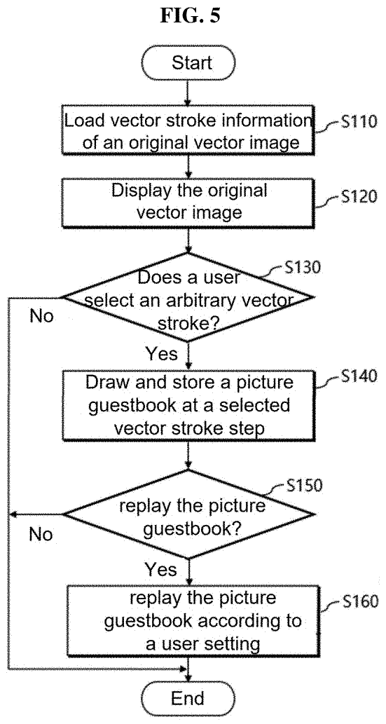

FIG. 5 is a flowchart showing a method of drawing and replaying a picture guestbook using a vector stroke according to one embodiment of the present invention.

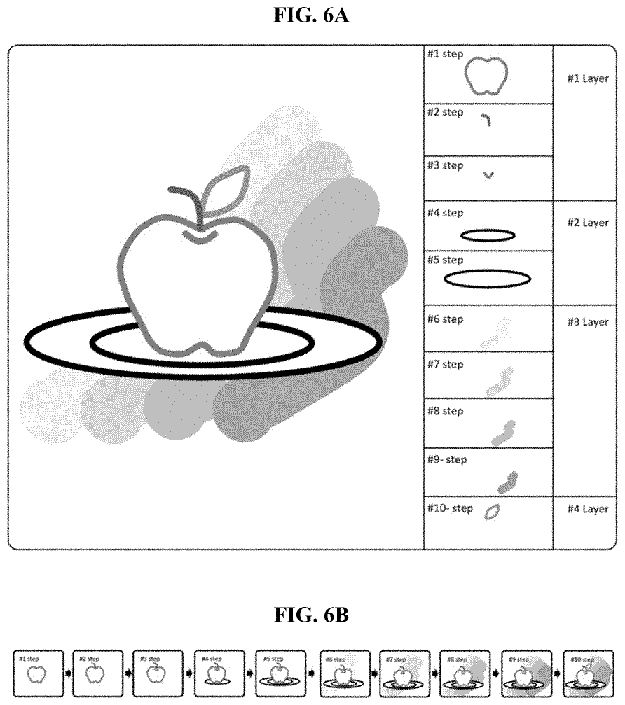

In FIG. 5, first, a control unit 140 may load vector stroke information of an original vector image for which a picture guestbook is to be drawn from a storage unit 130 (S110). In this case, according to one embodiment of the present invention, the original vector image may be an image drawn in a vector scheme. For example, as shown in FIG. 6A, when the original vector image is an apple picture, as shown in FIG. 6B, replaying an apple vector image, each stroke of the apple picture may be converted into a vector stroke, and information one the vector stroke may be stored in a chronological and sequential order of operation steps. When the apple picture has 10 strokes, information on 10 vector strokes #1 to #10 strokes may be stored in an order of operations.

In this case, although the operation steps have been divided on a stroke basis and shown as a static drawing for convenience of description, since an actual vector image is configured such that a process of sequentially moving about 200 to 500 input pointers per stroke is stored as an operation process, operation steps more than 10 steps shown in the drawing may be stored.

Thereafter, the control unit 140 may display the original vector image through a display unit 120 based on the vector stroke information of the original vector image (S120). In this case, the control unit 140 may display an entire image corresponding to a final operation step of the original vector image, or may sequentially replay the original vector images by redrawing step images for each operation step.

In general, when a user views a work for the first time, the user may select a scene preferred by the user after the original vector image is entirely replayed. However, in a case of a work that has been viewed several times, the user may directly select the scene preferred by the user while replaying the original vector image. Therefore, according to one embodiment of the present invention, a picture guestbook may be drawn on the entire image corresponding to the final operation step of the original vector image, or a picture guestbook may be drawn on a preferred image when the preferred image appears during replaying of the original vector image, so that the picture guestbook may be conveniently drawn.

Next, the control unit 140 may determine whether the user has selected any one of all vector strokes of the original vector image (S130). The control unit 140 may determine a selected vector stroke among all the vector strokes of the original vector image according to a user input. For example, when a virtual stroke is input on the original vector image, the control unit 140 may determine that a vector stroke making contact with the virtual stroke is selected.

When the vector stroke is selected as a result of the determination, the control unit 140 may detect an operation step of the selected vector stroke, and may receive a picture guestbook drawn on the original vector image based on the operation step (S140). In this case, the control unit 140 may store vector stroke information of vector strokes drawn in the picture guestbook in the storage unit 130.

Next, the control unit 140 may determine whether replaying of the picture guestbook has been requested (S150), and when the replaying of the picture guestbook is requested, the original vector image and the picture guestbook may be replayed according to a user setting (S160). For example, the control unit 140 may replay the original vector image and the picture guestbook together with each other.

Meanwhile, when any one of the vector strokes included in the original vector image is not selected in the step S130, and a picture guestbook replaying request is not input in the step S150, the control unit 140 may terminate a process.

In other words, according to one embodiment of the present invention, the user may draw a picture guestbook by directly selecting a vector stroke of a portion preferred by the user to draw a picture guestbook on the entire image corresponding to the final operation step of the original vector image, or by selecting the vector stroke when a scene preferred by the user is replayed during the replaying of the original vector image, so that a portion of the original vector image preferred by the user may be visually expressed.

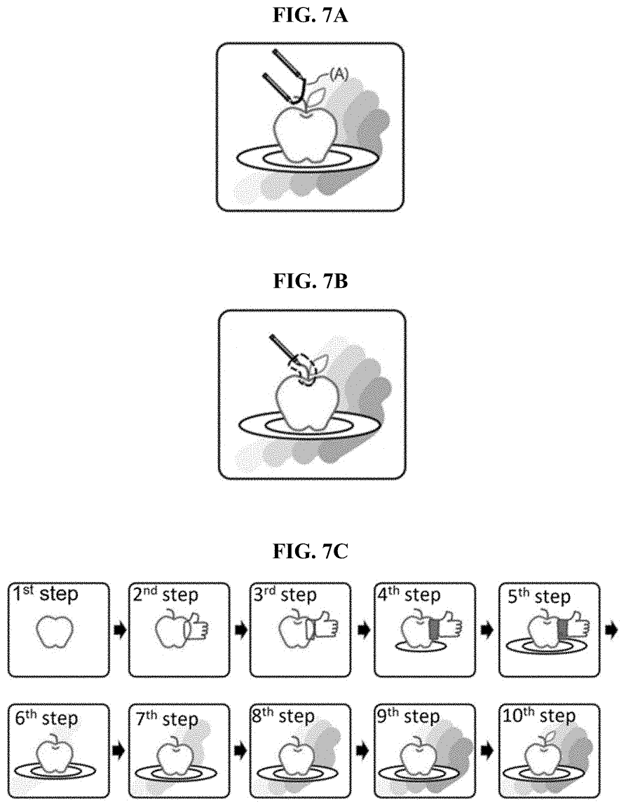

FIGS. 7A-7C are an exemplary view for describing a scheme of selecting a vector stroke for which a picture guestbook is to be drawn by a user according to one embodiment of the present invention.

In FIGS. 7A-7C, when a virtual stroke (A) is drawn by the user with the stroke-basis selection pen tool as shown in FIG. 7A while the image corresponding to the final operation step of the original vector image is displayed, strokes making contact with the stroke (A) may be consecutively selected on a stroke basis. In other words, as shown in FIG. 7B, a vector stroke (b) corresponding to an apple stem making contact with the stroke (A) may be selected. Then, as shown in FIG. 7C, a picture guestbook having a thumb shape representing a recommendation may be drawn from a second step, which is an operation step of drawing the apple stem.

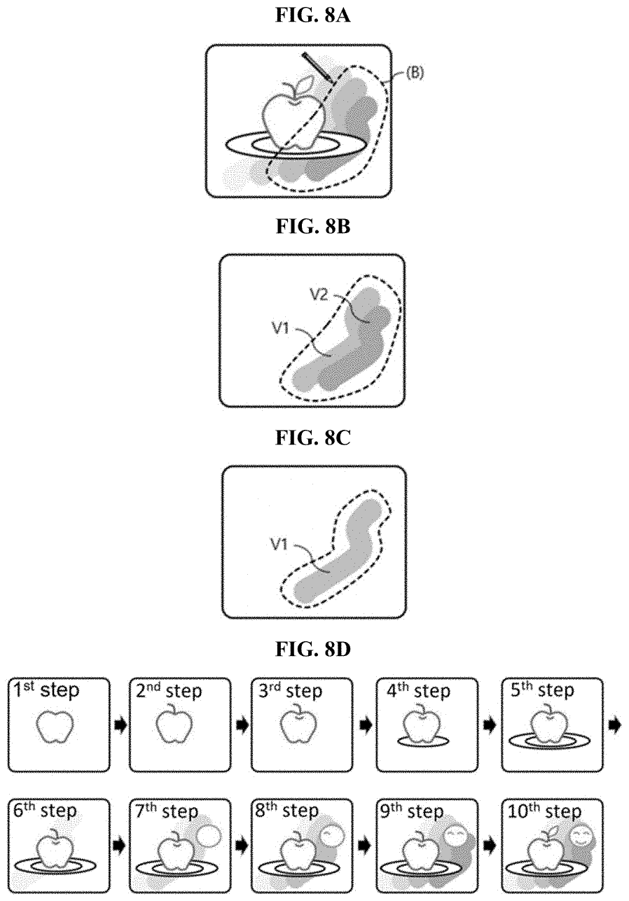

FIGS. 8A-8D are another exemplary view for describing a scheme of selecting a vector stroke for which a picture guestbook is to be drawn according to one embodiment of the present invention.

In FIGS. 8A-8D, when a figure (B) including a predetermined area is drawn by the user as shown in FIG. 8A while the image corresponding to the final operation step of the original vector image is displayed, as shown in FIG. 8B, vector strokes V1 and V2 included in an inner area of the figure B may be selected. In this case, according to one embodiment of the present invention, when a plurality of vector strokes are selected in the inner area of the figure (B), as shown in FIG. 8C, the control unit 140 may finally select the vector stroke V1 having a lowest operation level. Therefore, as shown in FIG. 8D, a picture guestbook having a smile shape may be drawn from a seventh step, which is an operation step corresponding to the vector stroke V1.

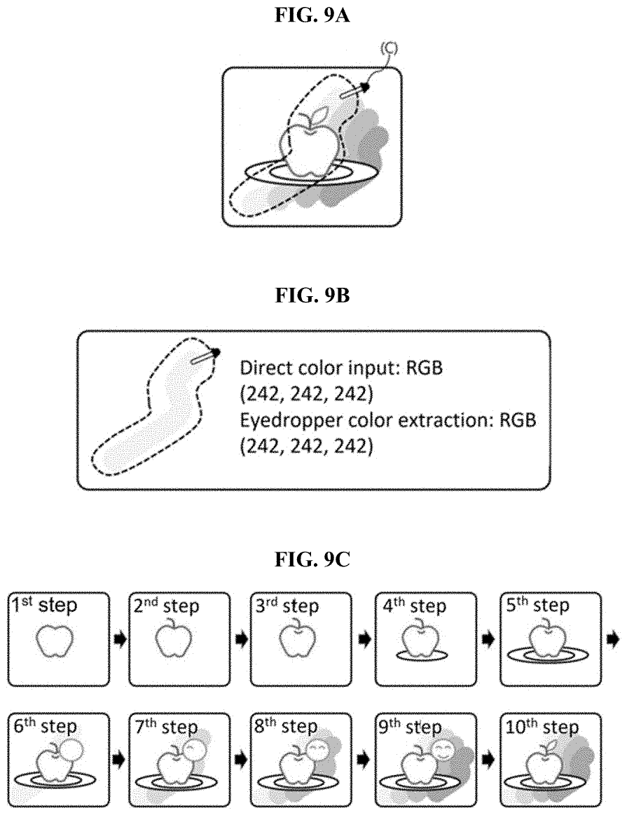

FIGS. 9A-9C are still another exemplary views for describing a scheme of selecting a vector stroke for which a picture guestbook is to be drawn by a user according to one embodiment of the present invention.

In FIG. 9A-9C, when a specific color is selected by the user with an eyedropper tool (C) as shown in FIG. 9A while the image corresponding to the final operation step of the original vector image is displayed, as shown in FIG. 9B, a color value of the selected color may be extracted. In this case, the user may directly input a color value instead of using the eyedropper tool. Then, as shown in FIG. 9C, a vector stroke corresponding to the color value may be selected, and a picture guestbook having a smile shape may be drawn from a seventh step, which is an operation step of the selected vector stroke.

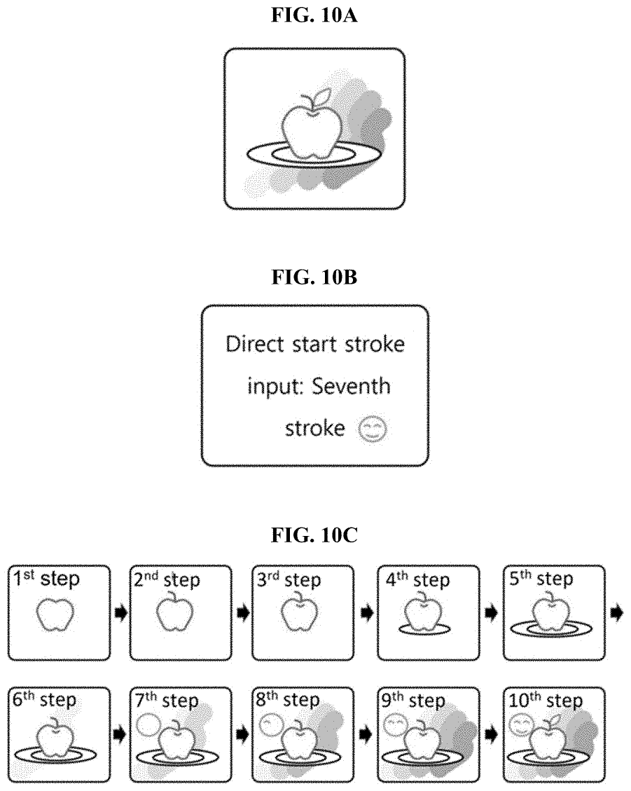

FIGS. 10A-10C are yet another exemplary view for describing a scheme of selecting a vector stroke for which a picture guestbook is to be drawn by a user according to one embodiment of the present invention.

In FIGS. 10A-10C, when a stroke order is input as a seventh stroke by the user as shown in FIG. 10B while the image (a) corresponding to the final operation step of the original vector image is displayed, as shown in FIG. 10C, a picture guestbook having a smile shape may be drawn from a seventh step, which is an operation step of a vector stroke corresponding to the seventh stroke.

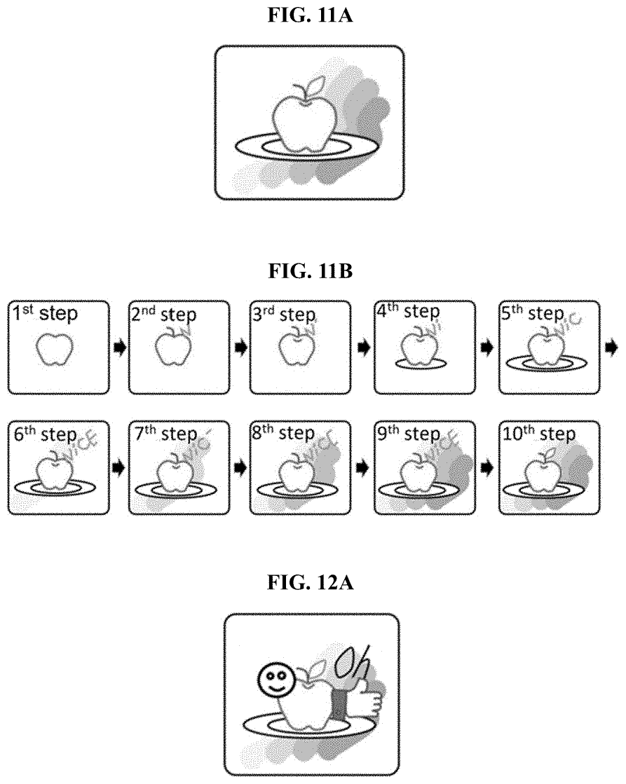

FIGS. 11A-11B are still yet another exemplary views for describing a scheme of selecting a vector stroke for which a picture guestbook is to be drawn by a user according to one embodiment of the present invention.

In FIGS. 11A-11B, when an apple stem vector stroke is selected by the user in a second step of drawing an apple stem while the original vector image (a) is replayed, as shown in FIG. 11B, a picture guestbook may be drawn as letters “Nice” with eight strokes from a second step.

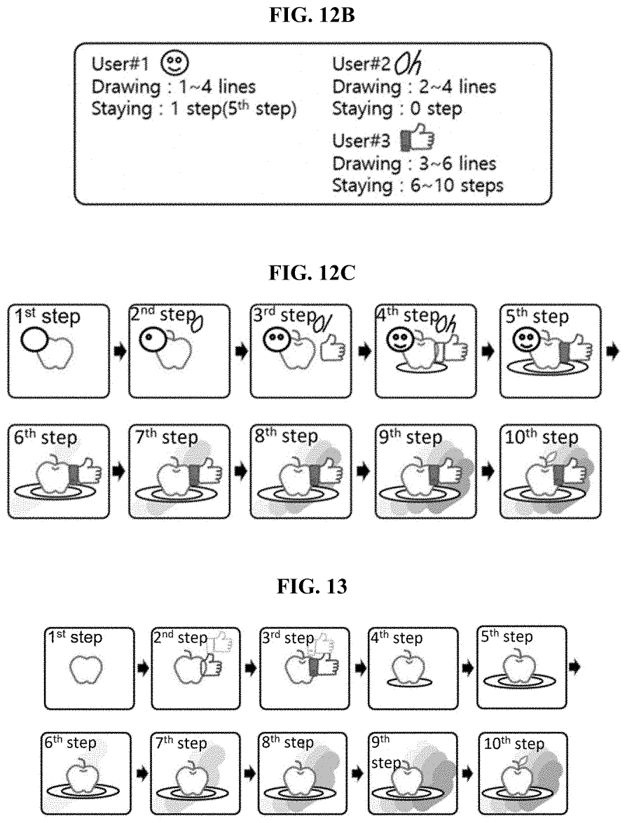

FIG. 12 is an exemplary view for describing a scheme of drawing a picture guestbook according to one embodiment of the present invention, and FIG. 13 is an exemplary view for describing actual replaying of the picture guestbook.

In FIGS. 12A-12C, a first user User #1 may draw a picture guestbook having a smile shape with four strokes from a first step while the original vector image is replayed, and set to maintain the picture guestbook for one stroke. A second user User #2 may draw a picture guestbook as letters “Oh” from a second step to a fourth step while the original vector image is replayed, and terminate a process without a holding time.

A third user User #3 may draw a picture guestbook having a thumb shape representing a recommendation from a third step to a sixth step while the original vector image is replayed, maintain the picture guestbook until a tenth step, and terminate a process.

As described above, while one original vector image is replayed, a plurality of users may simultaneously draw picture guestbooks. Although the above process has been expressed for each operation step to describe with static drawings, in reality, a picture guestbook may be drawn, stored, and replayed as if a picture is actually drawn according to an input speed for each time period. In other words, a replaying start time of each picture guestbook may be determined according to a drawing start order of the picture guestbook, and a replaying end time of the picture guestbook may be determined according to a drawing length of the picture guestbook.

Therefore, an actual picture guestbook may be drawn and replayed faster than an operation speed of the original vector image. This is because, while a stroke in one step is generally drawn with 200 to 500 input pointers when the stroke in one step is actually drawn, drawing speeds are mutually different for each user who draws a stroke, so that all the input pointers may not be expressed in the operation steps expressed on the drawing. For example, while a thumb shape representing a recommendation requires a drawing time of at least four steps, as shown in FIG. 13, a drawing speed may be fast so as to be completely drawn within two steps. In other words, the picture guestbook may be displayed on the original vector image with two operation steps being omitted.

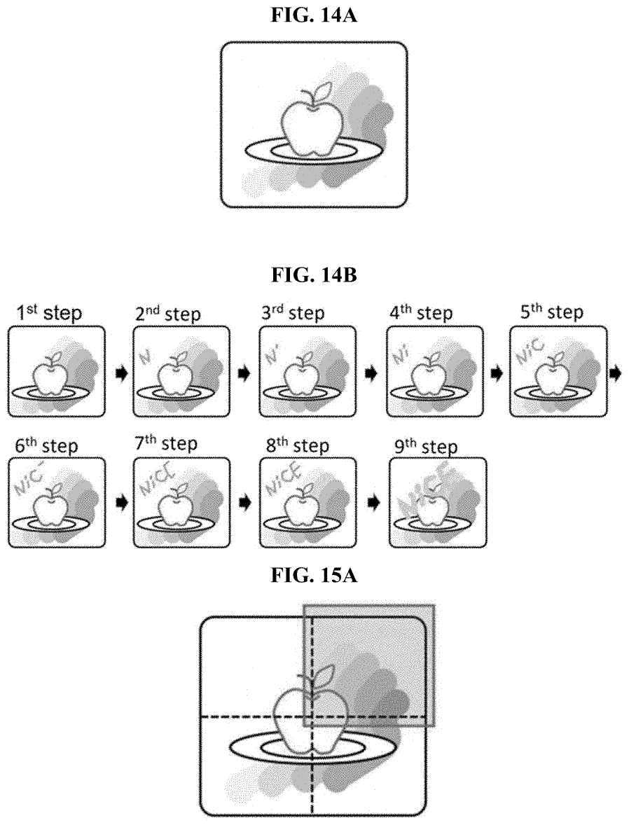

FIGS. 14A-14B are an exemplary view for describing modification of the picture guestbook according to one embodiment of the present invention.

In FIGS. 14A-14B, while the image (a) corresponding to the final operation step of the original vector image is displayed, as shown in FIG. 14(b), a picture guestbook may be drawn with seven strokes, and a color and a thickness of the picture guestbook may be modified. In other words, since a picture guestbook is drawn in a vector scheme according to one embodiment of the present invention, modification and editing are enabled.

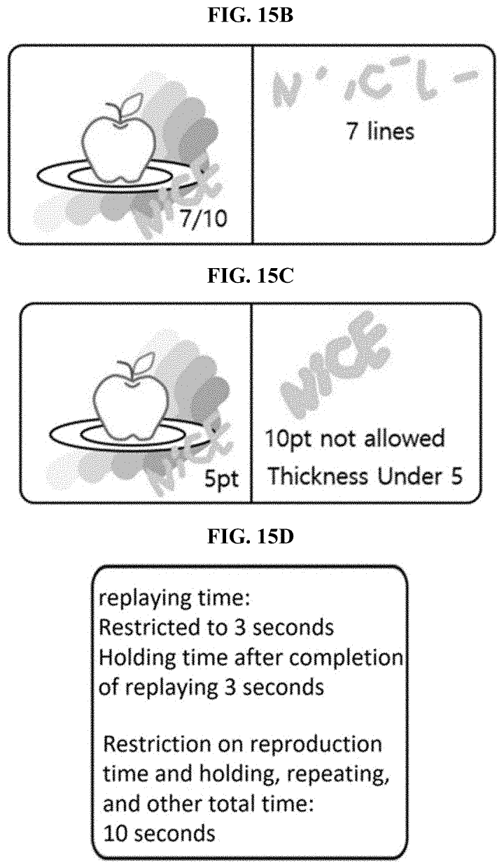

FIGS. 15A-15D are an exemplary view for describing restrictions on drawing the picture guestbook according to one embodiment of the present invention.

In FIGS. 15A-15D, according to one embodiment of the present invention, drawing of a picture guestbook may be restricted according to a preset rule for joint use of the picture guestbook. For example, as shown in FIG. 15A, an entire area of the original vector image may be divided into four areas, and the picture guestbook may be restricted to be used in only a ¼ area. In addition, as shown in FIG. 15B, a total number of strokes in the picture guestbook may be restricted to be less than 10, and as shown in FIG. 15C, a maximum thickness of the picture guestbook may be restricted to be less than 5 points. In addition, as shown in FIG. 15D, a total replaying time including a holding time of the picture guestbook may be restricted.

As described above, according to the method of drawing and replaying the picture guestbook using the vector stroke of one embodiment of the present invention, the picture guestbook may be drawn on a partial or entire area of the original vector image drawn by a creator. For example, when the creator produces a sunset glow image drawn in a vector scheme and uploads the work to the Internet or SNS, other users may directly draw picture guestbooks on the sunset glow image for various purposes such as a work review, a guestbook, and a comment.

When the sunset glow image is drawn with 100 strokes, and a process of replaying the sunset glow image having 100 strokes is sequentially replayed, one user may draw a picture guestbook on the sun in an operation step of drawing the sun, and another user may draw a picture guestbook in a step in which the work is completed.

In other words, the user may draw a picture guestbook by specifying a scene preferred by the user, and may replay the picture guestbook together with picture guestbooks drawn by other users. Therefore, empathy for the work and communication may be interactively enabled between the creator and the user or the user and another user as compared with a case where a work review, a guestbook, or the like is written in an input window that is provided separately from the original vector image as in a bitmap scheme.

Accordingly, the creator may recognize a portion of the work of the creator that other users like or dislike, and the user may more easily appreciate and understand the work by empathizing and sharing the work with other users.

In addition, since a replaying vector scheme rather than a static bitmap scheme is adopted, the work may be conveniently appreciated. Further, when the user selects picture guestbooks written by friends or group users of the user by using an SNS function, the user may appreciate the work with acquaintances, so that the appreciation of the work may become more enjoyable.

What is claimed is:

1. A method of drawing and replaying a picture guestbook using a vector stroke, the method comprising:
displaying an original vector image;
determining a selected vector stroke among all vector strokes of the original vector image according to a user input, and detecting an operation step of the selected vector stroke;
receiving a picture guestbook drawn on the original vector image, and obtaining vector stroke information of the picture guestbook based on the detected operation step; and
replaying the picture guestbook based on the vector stroke information of the original vector image.

2. The method of claim 1, wherein the displaying of the original vector image includes:
obtaining vector stroke information of the original vector image; and
displaying an image corresponding to a final operation step based on the vector stroke information of the original vector image.

3. The method of claim 1, wherein the displaying of the original vector image includes:
obtaining vector stroke information of the original vector image; and
sequentially replaying operation steps of the original vector image based on the vector stroke information of the original vector image.

4. The method of claim 1, wherein the determining of the selected vector stroke includes:
receiving a virtual stroke drawn on the original vector image by using a stroke-basis selection pen tool as a user input; and
determining a vector stroke making contact with the virtual stroke among all the vector strokes as the selected vector stroke.

5. The method of claim 1, wherein the determining of the selected vector stroke includes:
receiving a closed curve or a polygon drawn on the original vector image as a user input; and
determining a vector stroke included inside the closed curve or the polygon among all the vector strokes as the selected vector stroke.

6. The method of claim 1, wherein the determining of the selected vector stroke includes:
receiving a characters of color value or color value selected by using an eyedropper tool corresponding to a color value as a user input; and
determining a vector stroke having the color value corresponding to the character or the selected color among all the vector strokes as the selected vector stroke.

7. The method of claim 1, wherein the determining of the selected vector stroke includes:
receiving a character corresponding to a stroke order as a user input; and
determining a vector stroke corresponding to the stroke order among all the vector strokes as the selected vector stroke.

8. The method of claim 1, wherein the determining of the selected vector stroke includes determining, when a plurality of vector strokes are selected, one of the vector strokes as the selected vector stroke according to a preset user setting.

9. The method of claim 8, wherein the user setting is set to select one of a highest-order stroke, a lowest-order stroke, and an intermediate-order stroke.

10. The method of claim 1, wherein the vector stroke information includes operation step and attribute information on all vector strokes of the original vector image or the picture guestbook.

11. The method of claim 1, wherein the replaying of the picture guestbook includes
controlling at least one of a replaying speed and a viewing scheme of the picture guestbook according to a preset user setting.

12. The method of claim 11, wherein the replaying speed of the picture guestbook is set to be equal to a replaying speed of the original vector image, or set to be changed into a speed that is different from the replaying speed of the original vector image.

13. The method of claim 11, wherein the viewing scheme of the picture guestbook is set to replay simultaneously with the original vector image or to replay separately from the original vector image.

14. The method of claim 1, further comprising storing the vector stroke information of the picture guestbook in synchronization with the detected operation step of the vector stroke.

15. The method of claim 14, wherein the storing of the vector stroke information of the picture guestbook includes
inserting and storing the picture guestbook into the original vector image in a chronological and sequential order, or storing the picture guestbook separately from the original vector image.

16. The method of claim 1, wherein the receiving of the picture guestbook includes
restricting a number of strokes in the picture guestbook to a preset number of strokes.
